(19) United States
(12) Patent Application Publication
(10) Pub. No.: US 2019/0082660 A1
(43) Pub. Date: Mar. 21, 2019

(54) Process and Device to the Improve Wintering of Bees

(71) Applicant: Robert C. Ragsdale, Leesburg, VA (US)

(72) Inventor: Robert C. Ragsdale, Leesburg, VA (US)

(21) Appl. No.: 16/191,188

(22) Filed: Nov. 14, 2018

(51) Int. Cl. A01K 47/06; A01K 47/02

(52) U.S. Cl. CPC A01K 47/06; A01K 47/02

(57) ABSTRACT

The description relates to the discovery that the use of a bypass device for enabling bees to better survive winter in a hive containing a plurality of honey combs containing honey. In one aspect the device provides a passageway formed of two parallel planar surfaces defining an opening through a honey comb or support. The structural element is used in a bee hive to define a passage communicating from one face of a honey comb to an opposed face to better enable bees to survive winter on a limited supply of honey.

### FIELD OF THE INVENTION

The invention relates to a process and device to improve the wintering of bees.

### BACKGROUND OF THE INVENTION

Winter is a time of stress for bees. Beekeepers have obviously succeeded over the centuries in assuring the survival of their bees, and bees in the wild have survived as well. However, winter deaths and colony losses do damage operations or increase costs, and there is a real need to somehow reduce these negatives and provide an easy solution that enhances the bees ability to use their best survival skills within the confines of a man-made hive.

Winter brings cold and an absence of external food sources. The body temperature of a bee is greatly influenced by ambient air temperature. If a bee is unable to maintain a body temperature above approximately 41° F. the breathing movements of its abdomen will cease, and it will die. To conserve heat as the air temperature drops, the bees huddle together and form a relatively spherical mass known as the winter cluster. To generate enough heat to survive and maintain a winter cluster as close to 95° F. as possible, the bees shiver by rapidly contracting and relaxing their large thoracic flight muscles without moving their wings.

To maintain this activity and protect themselves and the queen from the cold, the bees need food for energy. It is essential to their survival during the cold months that there is food available in the hive and that the bees can remain in contact and access it. In the summer, the bees can fly for long distances to seek out food, but in winter when there are no external food sources available they are largely limited to the food they have stored in the hive, which is generally located above and to the sides of the cluster. To maintain the cluster temperatures the bees will follow the thermal column upwards along a face of a comb as they consume the food that is stored immediately above them. When warmer temperatures and internal passages allow it, the cluster may expand and shift so that a portion of it can reach adjacent combs to access food stores.

A fundamental concept in bee hive design is that of the bee space. A bee space defines the size of an opening that permits a bee to pass through. In bee hives with full frames, the frames are designed and arranged such that a bee space is created and maintained between the outer faces of the frames (the frame top-bars, bottom-bars, and side-bars) and the encasing hive body and components to allow for the movement of bees around the frames and the drawn combs secured therein.

Similarly, in top-bar hives, where the bars to which the comb is attached form the roof of the hive and there are no frame side or bottom bars, the bees generally leave a bee space between each comb and the side and bottom walls of the hive to allow for the movement of bees around the combs.

Additionally, the frames of full frame hives and the top-bars of top-bar hives are designed such that when they are placed in the hive they create a spacing that maintains a space between drawn combs of no less than one bee space and no more than two bee spaces so that the bees can freely move between the combs.

The free movement of bees throughout the hive is particularly important during the extended cold of winter. A well configured and provisioned colony will have stored its honey in the upper areas of its combs and the brood nest will be at the bottom going into the winter months. As the weather cools, the bees will form a tight winter cluster to stay warm. As there are no external food sources at this time of year, the colony will follow the thermal column created by the heat created by the clustered bees and slowly move vertically up the faces of the comb the cluster spans and consume the honey stores. At the point that the colony has reached the top and has consumed all of the honey on the faces of comb the cluster occupies, the cluster then must move to adjacent combs to access additional honey stores. Hive designs that do not facilitate the horizontal movement of bees from comb to comb can present insurmountable challenges for survival.

One drawback of top-bar hives is that bees cannot move over the top edges of a comb as it is attached to the surface above it, which is the lower plane of the top bar.

This inability to move over the top of the comb is exaggerated in the cold of winter as the bees may form a cluster in the center of the comb that is so small that it does not reach a side edge or bottom edge of the comb. In this situation the bees are often unable to move from their position between the faces of the combs they occupy to the faces of adjacent combs. As a result, they may run out of accessible food and perish.

Similarly, in full-frame hives when an item, such as a quilt, which is intended to insulate the bees and absorb moisture, is placed directly on the top-bars of frames, the bees are no longer able to move over the tops of the frames. In a full-frame hive, this situation can be further exacerbated as the design of many frames is such that the upper portion of the sidebar functions to space one frame from another and touches the adjacent frame's side-bar. This close contact of adjacent frame members creates a barrier wall at the side of the frames, and the bees cannot pass around from one frame to another to find new food. In this configuration also, the bees in a cluster are eating and moving to stay warm, but they may be unable to move to another comb face. As a result, they are at risk of running out of food and perishing.

Various attempts have been made to fashion communication holes to create a passage at the top of the comb, below the top bar. This has generally taken the form of hole punched through or corners knocked out of a foundation sheet with the hope that the bees will not fill them in. Frequently, however, the bees do fill in these holes using the space for the building of comb. A simple hole, by itself, is not enough to assure access between combs. Bees tend to fill in holes and not leave them as permanent passageways.

There is a current need for a process and device to improve the wintering of bees.

### SUMMARY OF THE INVENTION

The present invention provides a process and device to improve the wintering of bees in both top-bar and full-frame hives.

In one broad aspect, the invention provides a bypass device for enabling bees to better survive winter in a hive containing a plurality of combs containing honey, comprising a passageway formed of two parallel planar surfaces defining an opening through or over a comb.

From another perspective, the invention provides a structural element for use in a bee hive and defining a passage communicating from one face of a comb to an opposed face, the structural element being comprised a body having an opening therethrough which is defined by opposed parallel surfaces and having a depth which is approximately the distance between the faces of the comb.

In another aspect the process comprises: providing a top-bar hive body with an active bee population including at least worker bees and a queen within the hive body, the hive body being comprised of a pair of parallel, opposed end walls, a bottom wall connecting the end walls and side walls connected to the end walls and opposite sides, each side wall diverging upwardly from the bottom wall and configured to support a plurality of top bars, which are adapted to support a downwardly formed comb having opposed parallel faces; extending a plurality of top bars between the side walls to support said top bars over the hive body; for each top bar, providing a bypass channel defined by two spaced, parallel surfaces incorporated in or proximate to the top bar, wherein each of the two parallel surfaces has a width parallel to the surfaces of at least one bee space and as much as a full horizontal extent of a face of a comb, said parallel surfaces being spaced from each other by a height, transverse to a face of a comb, of from one to two bee spaces, said parallel surfaces having a depth, transverse to the comb faces, which is approximately the distance between the faces of a comb, and wherein each of said parallel surfaces of a bypass channel is spaced from a like surface of a bypass channel of an adjacent top bar by from one to two bee spaces; and, providing combs containing honey and pollen below bypass channels associated with a plurality of top bars, the total amount of honey and pollen in the hive being sufficient to feed the bees during the winter. In one embodiment, the honey and pollen in the combs is the only food source in the hive for the bees for the entire winter.

In another aspect the invention provides a bypass device for enabling bees to better survive winter in a hive containing a plurality of combs, a plurality of which contain honey available bees, comprising: a body having an opening therethrough which is defined by opposed parallel surfaces, each of which has a width parallel to the surfaces of at least one bee space and as much as a full horizontal extent of a face of a comb, said parallel surfaces being spaced from each other by a height, transverse to the width, of from one to two bee spaces, said parallel surfaces having a depth, transverse to the comb faces, which is approximately of from one to two bee spaces. This device can be either secured to or formed at least in part by a top bar of a top-bar hive or to a top frame member of a full-frame hive.

From another perspective, the body of the bypass device comprises an integral depending support or guide for the bees to attach and build their comb.

Other preferred aspects, including preferred structures, materials, and procedures and their advantages, are set out in the description which follows.

### BRIEF DESCRIPTION OF THE DRAWINGS

The invention will be better understood and its advantages will become more apparent when the following detailed description is read in conjunction with the accompanying drawings, in which:

FIG. 1 is a perspective view of one exemplary simplified embodiment of the invention.

FIG. 1a is a perspective view of an alternative structure of the embodiment of FIG. 1;

FIG. 2 is a cross section taken along line 2-2 in FIG. 1.

FIG. 3 is a perspective view of a top-bar hive.

FIG. 4 is a front elevation of a comb of a top-bar hive having a bypass device according to the invention;

FIG. 5 is a cross sectional view taken along line 5-5 in FIG. 4.

FIG. 6 is a perspective view of a rectangular frame within full-frame beehive, e.g., a Langstroth hive.

FIG. 6a is a perspective view of an alternative structure of the embodiment of FIG. 6;

FIG. 7 is an exploded perspective view of a representative Langstroth hive.

### DETAILED DESCRIPTION OF THE INVENTION

The present invention provides a process and device to improve the wintering of bees.

As will become more apparent from this description, the invention is applicable to improving wintering in both top-bar hives and full-frame hives, such as Langstroth hives, which use frames to support the combs. To simplify terminology and provide for consistency, the term “top bar” is used in this description to describe both: (1) the movable, top bar, sometimes called a roof bar, that bees attach the comb they construct combs in a top-bar hive, and (2) the top frame member of a rectangular frame within a full-frame beehive. Also by way of definition, the term “bee space” is used to describe a gap rarely filled with propolis or comb that bees naturally create to enable them to pass freely around their nest. This gap can be seen if a wild colony is taken out of a building or tree and herein defines the size of an opening that permits a bee to pass through, typically from about ¼ to ½ inch, with ⅜ inch being a reasonable average, e.g., from about 0.3 to 0.4 inches.

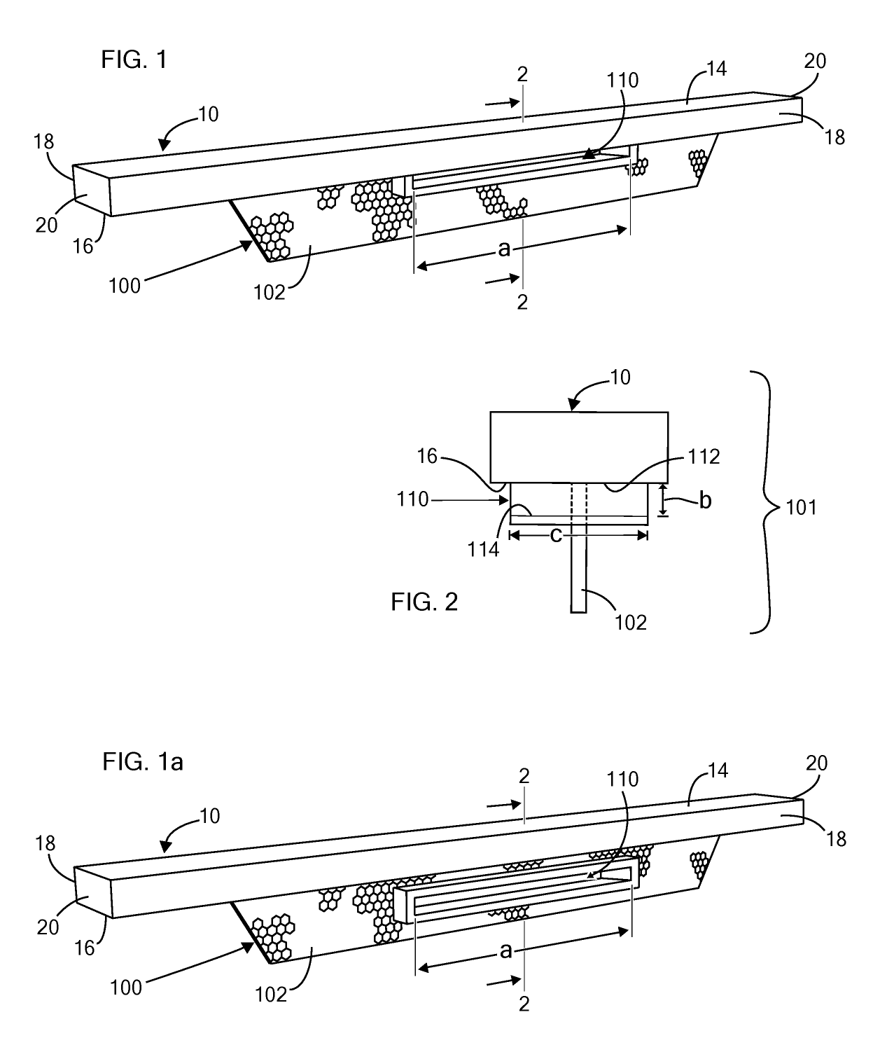

Every bee hive will contain a plurality of comb support means, e.g., 102, arranged to encourage an orderly arrangement of combs within the hive. For top-bar hives, a top bar 10, is shown in the perspective view of FIG. 1 as supporting an exemplary passthrough device 100 of the invention, which is shown to support a comb 120 (FIG. 3). The top bar 10 will typically comprise an elongated wooden bar having a rectangular cross section, the wooden bar having a top surface 14, a bottom surface 16, two side surfaces 18 and two ends 20. The bottom surface 16 will typically support a support means, which extend downward function to support a comb and as a guide, which can be a precise design as shown as 102 or a simple extension of a wood strip similar to a Popsicle® frozen dessert stick, to help the bees build their combs straight along a straight line at the bottom 16 of the top bar 10 as the comb is built to extend downward into the hive body.

The present invention provides a passthrough device 100 which can be attached to or integral with the top bar 10 to enable bees to better survive the rigors of winter. In some embodiments, the top bar 10 and the passthrough device 100 can be molded as an integral structure. The passthrough device can be made by a craftsman of any suitable material or combination of materials suitable for use in bee hives, but can also be made by molding of a suitable polymeric material by any suitable technique, including 3-D printing.

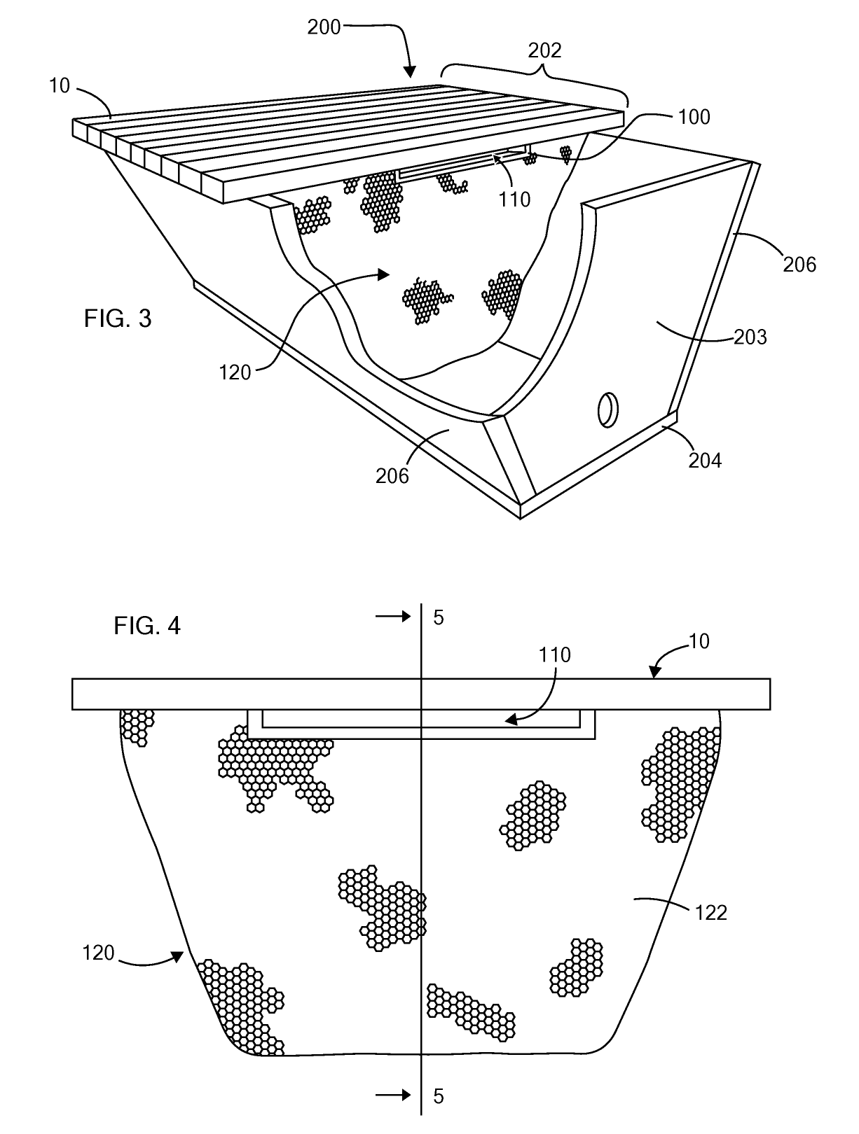

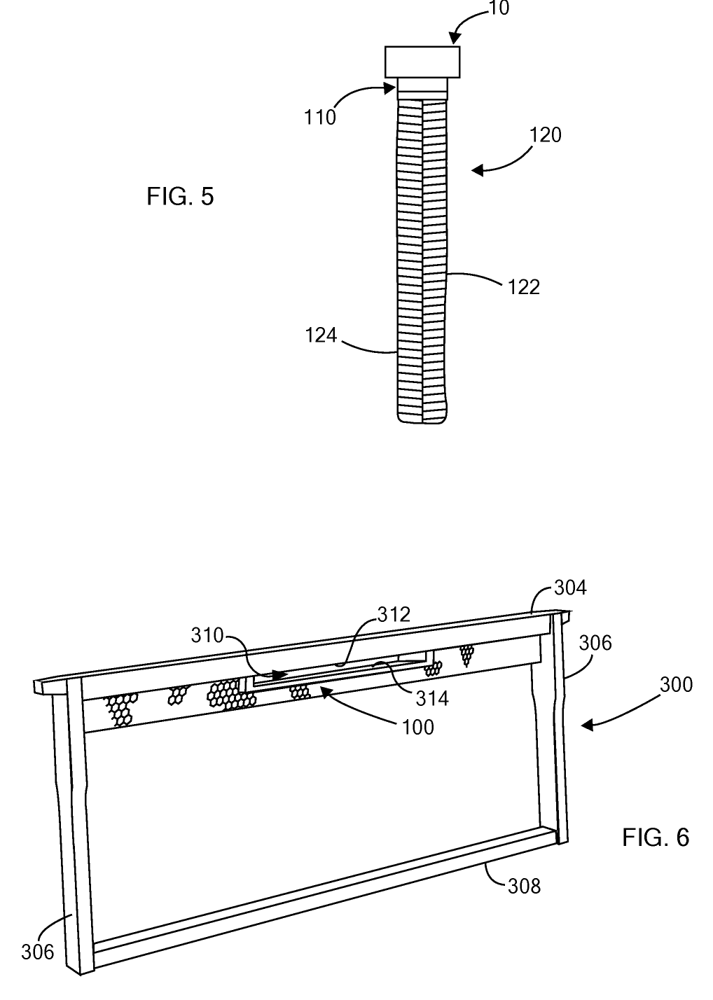

FIG. 2 is a cross section taken along line 2-2 in FIG. 1 and shows a top bar 10 associated with a passthrough device 100 to provide at least one bypass channel 110 that creates a communication channel from one face of a comb, e.g., (see FIG. 5) 122, to an opposite face 124 of the same comb. Each bypass channel 110 is comprised in a body 101 and is defined by two spaced parallel surfaces 112 and 114. Surface 112 can comprise a portion of the bottom surface 16 of top bar 10, as in FIG. 1a, which illustrates surface 112 as being a portion of surface 16. In another embodiment, both surfaces 112 and 114 can be lower than the surface 16 as shown in FIG. 1a. The lower surface 114 is shown as integral with the passthrough device 100 though the parts can be made separately and then assembled. In all embodiments the two surfaces will be incorporated in or proximate to the top bar 10. The surfaces having a width a parallel to the surfaces of from at least one bee space and as much as a full horizontal extent of the faces 122 or 124 of a comb and being spaced from each other by from one to two bee spaces. The extension 102 below the bypass channel defined by the structure including the surfaces 112 and 114 provides a guide to encourage the bees to build their combs in a straight line.

FIG. 1a is a perspective view of an alternative structure of the embodiment of FIG. 1. In this embodiment, the top bar 10 is prepared with a channel 110 including the two spaced parallel surfaces 112 and 114 integrally formed as a unit.

FIG. 3 is a perspective view of a top-bar hive 200 with only a limited number of top bars 10 for ease of understanding the structure. In the complete top-bar hives, there will be top bars 10 across the entire top 202 of the hive. In the usual construction, the top bars 10, will be pressed next to each other to form a continuous top on the hive body. The bees will assure that the structure is water tight by sealing all cracks with a resinous secretion called propolis. A top-bar hive body is comprised of a pair of parallel, opposed end walls 203, a bottom wall 204 connecting the end walls and two side walls 206 connected to the end walls and opposite sides on the bottom wall. Each side wall diverges upwardly from the bottom wall and is configured to support a plurality of top bars. A plurality of top bars 10 are shown extended between the side walls 206 to support the top bars 10 over the hive body.

FIG. 3 shows a plurality of top bars 10 supported by and extending between the side walls 206 to support the top bars 10 over the hive body. For each top bar 10, a passthrough device 100 is provided. Each passthrough device 100 has a bypass channel 110 defined by two spaced, parallel surfaces 112 and 114. These parallel surfaces 112 and 114 are incorporated in or proximate to the top bar 10. Each of the two parallel surfaces 112 and 114 has a has a width a parallel to the surfaces of at least one bee space and as much as a full horizontal extent of the faces 122 or 124 of a comb, said parallel surfaces being spaced from each other by a height b, transverse to the width, of from one to two bee spaces. In addition, the parallel surfaces 112 and 114 have a depth C, transverse to the comb faces, which is approximately the distance between the faces of a comb, and wherein each of said parallel surfaces 112 and 114 of a bypass channel is spaced from a like surface of a bypass channel 110 of an adjacent top bar by from one to two bee spaces.

FIG. 4 is a elevation showing greater detail of a comb of a top-bar hive having a bypass device according to the invention, and FIG. 5 is a cross sectional view taken along line 5-5 in FIG. 4.

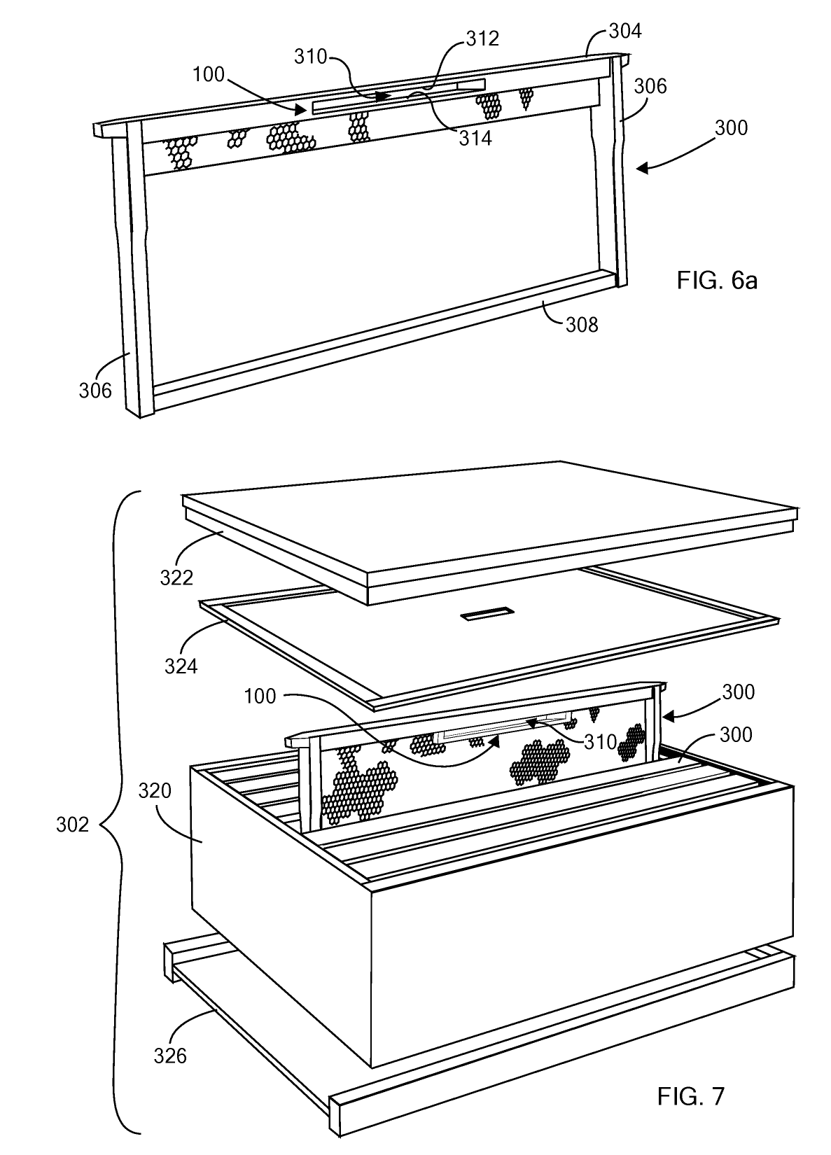

FIG. 6 is a perspective view of a rectangular frame within a full-frame hive of the Langstroth-type and FIG. 7 is an exploded perspective view of a representative Langstroth hive 302. FIG. 6a is a perspective view of an alternative structure of the embodiment of FIG. 6. A distinguishing feature of Langstroth hives is the use of frames, such as shown as 300, which will typically have a top frame member 304, two opposed end frame members 306 and a bottom frame member 308. The top frame member 304 and the bottom frame member 308 will each typically have grooves for holding a sheet of foundation material (not shown) as a guide and support for comb construction. In a full-frame hive, the passthrough device 100 will be formed integrally with the top frame member 304 or for attachment to it. The passthrough device 100 will have a bypass channel 310 defined by two spaced, parallel surfaces, the lower of which is shown as 314 and the other, surface 312, is on the upper side of channel 310, and cannot be seen. The dimensions of the spaced parallel surfaces, 312 and 314 in, 6a and 7, will be the same in this embodiment as they are for the embodiment of the top-bar hive. As noted above, the top frame member 304 for this type of hive is accurately referred to as a top bar because although the top bar 10 and the top frame member 304 have different structural features peculiar to the type of hive structure, they perform the same important functions according to the invention.

A typical full-frame hive, e.g., as in FIG. 7, will include a body section 320, a top outer cover 322, an inner cover 324 and a floor 326 in addition to the frames 300. There are many variations to the hive structure, but for the purposes of this description, we have simplified the detail.

In operation, during winter, the bee hive must maintain a bee colony healthy throughout the winter, when outside temperatures are cold and outside food sources are very limited if not absent. A beekeeper may supply added food as is known, where that is convenient and economical, but it would be desirable for bees to be able to survive a winter and be healthy when food sources return in the warmer weather. According to an important aspect of the invention a process is provided to help a hive survive a winter. In operation, a top-bar hive body with an active bee population including at least worker bees and a queen within the hive is provided. The hive can have a top-bar or Langstroth configuration. For the top-bar hive, the body is comprised of a pair of parallel, opposed end walls, a bottom wall connecting the end walls and side walls connected to the end walls and opposite sides, each side wall diverging upwardly from the bottom wall and configured to support a plurality of top bars. A plurality of top bars are extended between the side walls to support said top bars over the hive body. To provide a rich food environment in the hive, it is assured that at least some of the combs contain honey and pollen as food.

Bypass channels are preferably associated with a plurality of top bars. Bypass channels are defined by two spaced, parallel surfaces as described above. The configuration enables the free movement of bees throughout the hive during the extended cold of winter. During the warmer months the bees have stored honey and pollen at the top of the combs and the brood nest will be at the bottom going into the winter months. As the weather cools, the bees will form a tight winter cluster to stay warm. As there are no external food sources at this time of year, the colony will follow the thermal column created by the heat the clustered bees create and slowly move vertically up the faces of the comb the cluster spans and consume the honey stores. At the point that the colony has reached the top and has consumed all of the honey on the faces of comb they occupy, they then can move to an adjacent comb to access additional honey stores by passing through the bypass channels provided. And, due to the dimensions of the bypass channels, the bees will not fill them in. The bee hives constructed and operated within these guidelines will permit the honey and pollen in the combs to enable the bees to survive with this as the only food source in the hive for the entire winter.

The above description is for the purpose of teaching the person of ordinary skill in the art how to practice the invention. It is not intended to detail all of those obvious modifications and variations, which will become apparent to the skilled worker upon reading the description. It is intended, however, that all such obvious modifications and variations be included within the scope of the invention which is defined by the following claims. The claims are meant to cover the claimed components and steps in any sequence that is effective to meet the objectives there intended, unless the context specifically indicates the contrary.

1. A process for wintering bees in a top-bar hive, comprising:
a. providing a top-bar hive body with an active bee population including at least worker bees and a queen within the hive body, the hive body being comprised of a pair of parallel, opposed end walls, a bottom wall connecting the end walls and side walls connected to the end walls and opposite sides, each side wall diverging upwardly from the bottom wall and configured to support a plurality of top bars;
b. extending a plurality of top bars between the side walls to support said top bars over the hive body;
c. for each top bar, providing a bypass channel defined by two spaced, parallel surfaces incorporated in or proximate to the top bar, wherein each of the two parallel surfaces has a width parallel to the surfaces of at least one bee space and as much as a full horizontal extent of a face of a comb, said parallel surfaces being spaced from each other by a height, transverse to the width, of from one to two bee spaces, said parallel surfaces having a depth, transverse to the comb faces, which is approximately the distance between the faces of a comb, and wherein each of said parallel surfaces of a bypass channel is spaced from a like surface of a bypass channel of an adjacent top bar by from one to two bee spaces; and,
d. providing combs containing honey and pollen below bypass channels associated with a plurality of top bars.

2. A process according to claim 1, wherein the total amount of honey and pollen in the hive being sufficient to feed the bees during the winter.

3. A process according to claim 1, including the further step of placing a cover over the top bars.

4. A bypass device for enabling bees to better survive winter in a hive containing a plurality of combs containing honey available bees at two faces, comprising: a body having an opening therethrough which is defined by opposed parallel surfaces, each of which has a width parallel to the surfaces of at least one bee space and as much as a full horizontal extent of a face of a comb, said parallel surfaces being spaced from each other by a height, transverse to the width, of from one to two bee spaces, said parallel surfaces having a depth, transverse to the comb faces, which is approximately of from one to two bee spaces. This device can be either secured to a top bar of a top-bar hive or to a top frame of a full-frame hive.

5. A bypass device according to claim 4, further comprising support means for bees to attach and build their comb from.

6. A device according to claim 4, wherein the bypass device is secured to a top bar of a top-bar hive.

7. A device according to claim 5, wherein the bypass device is secured to a top frame member of a comb support frame.

8. A device for enabling bees to better survive winter in a hive containing a plurality of honey combs, a plurality of which contain honey, comprising:
a. for each a top bar for a top-bar hive or a top frame member of a honey comb support frame, a bypass device to enable bees to pass from one comb to another within a hive;
b. each bypass device comprising a support integral with or for connecting to an upper portion of a comb support means which extend downward to support a comb.

9. A bypass device for enabling bees to better survive winter in a hive containing a plurality of honey combs containing honey, comprising a passageway formed of two parallel planar surfaces defining an opening from one face of a comb to an opposite face.

10. A structural element for use in a bee hive and defining a passage communicating from one face of a comb to an opposed face, the structural element being comprised of parallel, flat surfaces, the depth of which is approximately the thickness of an associated honey comb.

11. A composite structure comprised of a honey comb and a structural element according to claim 10, wherein the passage is situated at an interface of a top-bar and the honey comb where the comb is attached to the top bar.

12. A bypass device for enabling bees to better survive winter in a hive containing a plurality of combs containing honey, comprising a passageway formed of two parallel planar surfaces defining an opening through or over a comb.

13. A structural element for use in a bee hive and defining a passage communicating from one face of a comb to an opposed face, the structural element being comprised a body having an opening therethrough which is defined by opposed parallel surfaces and having a depth which is approximately the distance between the faces of the comb.
